(19) United States
(12) Patent Application Publication
(10) Pub. No.: US 2008/0134989 A1
(43) Pub. Date: Jun. 12, 2008

(54) Leash assembly for animals

(76) Inventor: Emily Weiss, Benton, KS (US)

Correspondence Address: DILWORTH & BARRESE, LLP, 333 EARLE OVINGTON BLVD., SUITE 702, UNIONDALE, NY, 11553, US

(21) Appl. No.: 11/635,269

(22) Filed: Dec. 7, 2006

(51) Int. Cl. A01K 27/00

(52) U.S. Cl. 119/793; 119/792

(57) ABSTRACT

A leash assembly for use with an animal neck collar includes a cord having a handle portion at one end, a terminal loop at the other end, and a lengthwise portion of the cord therebetween; a ring attached to the terminal loop and through which the lengthwise portion of the cord is slidably disposed so as to provide a loop of adjustable size formed by a section of the lengthwise portion of the cord between the ring and the terminal loop; a fastener for removably attaching the leash assembly to a dog collar; and, a disk shaped stop member removably attachable to the lengthwise portion of the cord.

### BACKGROUND

1. Field of the Invention

The present invention relates to a leash assembly for training animals, and more particularly to a leash assembly for dogs.

2. Background of the Art

Various training leashes are known in the art. For example, U.S. Pat. No. 5,791,295 to Schmid et al. discloses a training leash for use with an animal neck collar including a band having a first end and a second end, the band having a length defined between the first end and the second end. A first ring is mounted on the first end of the band, a first portion of the length of the band being received through the first ring, defining a loop encircling a torso of an animal. A second ring is slidingly mounted on the band and mounted on the collar. A second portion of the length of the band, between the first ring and the second ring, defines a distance which varies as a tension of the band varies.

U.S. Pat. No. 4,270,491 to Cox discloses a figure eight choke leash for domestic pet or veterinary usage which employs a free-sliding quick adjusting ring, a cooperating quick release and quick engageable leash mounted adjuster and an adjustable stop button which regulates the ultimate size of the choke or noose portion of the leash.

More recently an improved leash sold under the mark The Weiss Walkie™ has been marketed as a tool for walking a dog which humanely stops the dog from pulling without having to tug or otherwise correct the dog. A portion of The Weiss Walkie™ leash extends around the torso of the dog and automatically applies moderate pressure around the dog's chest so as to calm and relax the dog. The dog naturally decreases forward movement.

An improvement to The Weiss Walkie™ leash is provided herein which prevents the leash from loosening when the leash becomes slack, for example, when the dog remains still.

### SUMMARY

A leash assembly for use with an animal neck collar is provided herein. The leash assembly includes a cord having a handle portion at one end, a terminal loop at the other end, and a lengthwise portion of the cord therebetween; a ring attached to the terminal loop and through which the lengthwise portion of the cord is slidably disposed so as to provide a loop of adjustable size formed by a section of the lengthwise portion of the cord between the ring and the terminal loop; a fastener for removably attaching the leash assembly to a dog collar; and, a disk shaped stop member removably attachable to the lengthwise portion of the cord.

### BRIEF DESCRIPTION OF THE DRAWINGS

Various embodiments are described below with reference to the drawings wherein:

FIG. 1 illustrates the leash assembly of the present invention;

FIG. 2 is perspective view of the stop member; and

FIGS. 3 and 4 illustrate the positioning of the leash assembly secured to an animal.

### DETAILED DESCRIPTION OF PREFERRED EMBODIMENT(S)

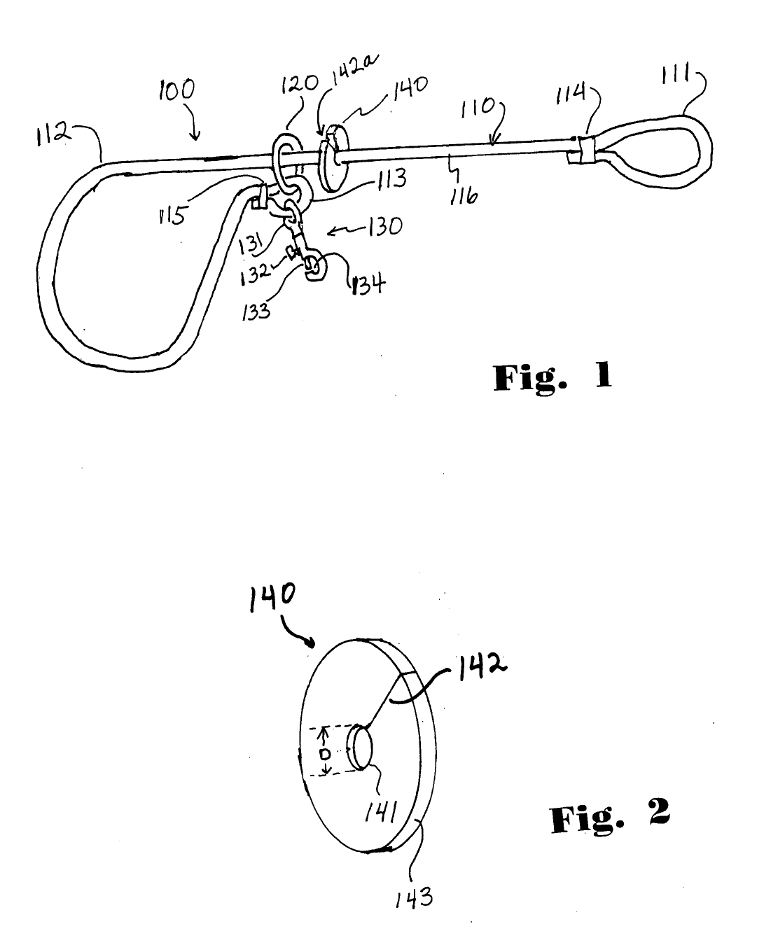

Referring to FIG. 1, the leash assembly 100 of the invention includes a cord, or rope, 110 having a handle portion 111 at one end, a terminal loop 113 at the other end, and a lengthwise portion 116 extension therebetween. The cord can be fabricated from any material suitable for the purposes described herein.

The handle 111 is preferably a loop fixed in size by fastener 114, although any other type of handle can be employed. The terminal loop 113 is fixed in size by fastener 115.

A ring 120 is attached to terminal loop 113. The ring 120 is preferably fabricated from metal such as iron, steel, aluminum, brass and the like, but can alternatively be fabricated from a high strength engineering plastic such as polycarbonate, acrylic, PVC and the like. The lengthwise portion of cord 116 is slidably disposed through ring 120 so as to be freely movable. A section of the cord 110 extending between the ring 120 and the terminal loop 113 forms a loop 112 of adjustable size which can be fitted around the torso of the animal. The eye 131 of snap clip fastener 130 is attached to the terminal loop 113. Snap clip fastener 130 includes a spring loaded lever 132 and a segment 133 which is movable between an open position and closed position to provide access to region 134 for attachment to an animal collar.

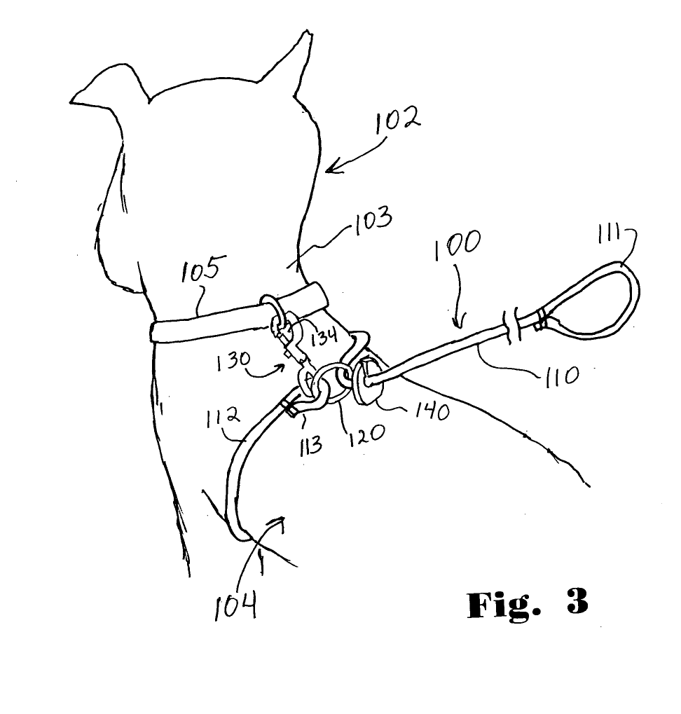

Referring also now to FIG. 2, the present invention includes a disk shaped stop member 140 fabricated from a resilient material such as natural rubber, synthetic polymeric materials such as plasticized PVC, neoprene, and the like. Stop member 140 includes an aperture 141 and a radial slit 142 extending from the aperture 141 to the outer circumferential edge 143 of the stop member. Aperture 141 is preferably centrally located, but can alternatively be positioned in a non-concentric location on the disk. In an embodiment of the invention aperture 141 has a diameter D which is less than the diameter of the cord 110. The stop member can be removably positioned on the lengthwise portion of the cord 116 between the ring 112 and the handle 111 such that the cord extends through the aperture 141.

Because the aperture 141 is of smaller diameter than the cord 110, the slit 141 is forced to open to form a gap 142a. However, the resiliency of the stop member 140 provides a biasing force to close gap 142a, thereby more tightly gripping the cord 110 so as to maintain the position of the stop member on the lengthwise portion 116 of the cord.

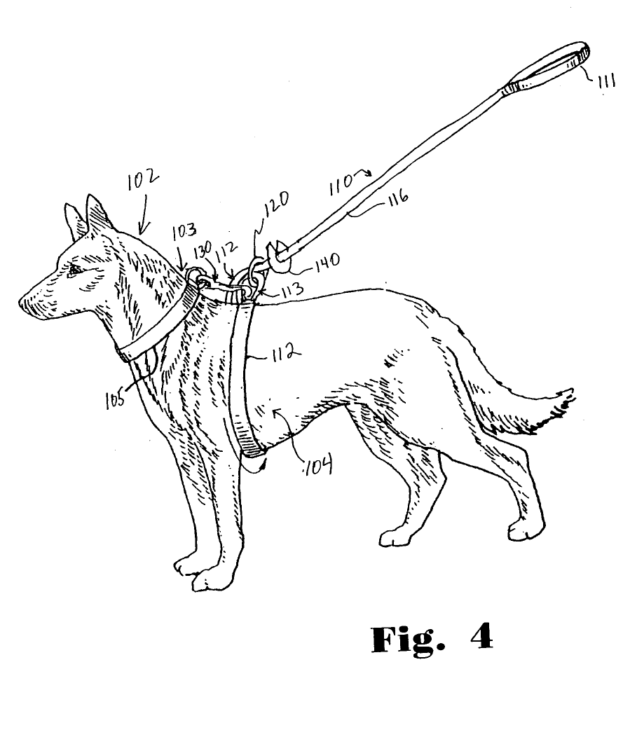

Referring now to FIGS. 3 and 4, the operation of the leash assembly of the invention is illustrated. The leash assembly is fitted on the animal 102 such that the adjustable loop 112 extends around the torso 104 of the animal. Snap clip 130 is attached to the collar 105 extending around the neck 103 of the animal. After the leash assembly is adjusted such that adjustable loop 112 fits comfortably yet snugly around the torso 104 of the animal, the stop member 140 is placed on the lengthwise portion 116 of the cord behind ring 120 to inhibit the ring from sliding up towards handle 111. This prevents loop 112 from undesirably loosening while walking the animal.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A leash assembly for use with an animal neck collar, comprising:
a) a cord having a handle portion at one end, a terminal loop at the other end, and a lengthwise portion of the cord therebetween;
b) a ring attached to the terminal loop and through which the lengthwise portion of the cord is slidably disposed so as to provide a loop of adjustable size formed by a section of the lengthwise portion of the cord between the ring and the terminal loop;
c) a fastener attached to the terminal loop for removably attaching the leash assembly to an animal collar; and,
d) stop mean removably attachable to the lengthwise portion of the cord for inhibiting sliding movement of the ring towards the handle portion.

2. The leash assembly of claim 1 wherein the stop means is a disk shaped stop member fabricated from a resilient material.

3. The leash assembly of claim 2 wherein the disk shaped stop member includes an aperture and a radial slit extending from the aperture to a peripheral circumferential edge of the stop member.

4. The leash assembly of claim 3 wherein the aperture has a first diameter and the cord has a second diameter, wherein the first diameter is less than the second diameter.

5. The leash assembly of claim 2 wherein the resilient material is a natural rubber or a synthetic polymeric material.

6. The leash assembly of claim 1 wherein the fastener (c) is a spring biased snap fastener.

7. The leash assembly of claim 1 wherein the ring is fabricated from a material selected from the group consisting of iron, steel, aluminum, brass, polycarbonate, acrylic and PVC.

8. The leash assembly of claim 1 wherein the stop member is positioned on the lengthwise portion of the cord between the ring and the handle portion.

9. A leash assembly for use with an animal neck collar, comprising:
a) a cord having a handle portion at one end, a terminal loop at the other end, and a lengthwise portion of the cord therebetween;
b) a ring attached to the terminal loop and through which the lengthwise portion of the cord is slidably disposed so as to provide a loop of adjustable size formed by a section of the lengthwise portion of the cord between the ring and the terminal loop;
c) a fastener for removably attaching the leash assembly to an animal collar; and,
d) a disk shaped stop member removably attachable to the lengthwise portion of the cord.

10. The leash assembly of claim 9 wherein the disk shaped stop member is fabricated from a resilient material.

11. The leash assembly of claim 10 wherein the disk shaped stop member includes an aperture and a radial slit extending from the aperture to a peripheral circumferential edge of the stop member.

12. The leash assembly of claim 11 wherein the aperture has a first diameter and the cord has a second diameter wherein the first diameter is less than the second diameter.

13. The leash assembly of claim 10 wherein the resilient material is a natural rubber or a synthetic polymeric material.

14. The leash assembly of claim 9 wherein the fastener (c) is a spring biased snap fastener coupled to the terminal loop.

15. The leash assembly of claim 9 wherein the stop member is positioned on the lengthwise portion of the cord between the ring and the handle portion.

16. A method for walking an animal comprising the steps of:
a) fastening a collar around the neck of the animal;
b) providing a leash assembly including
i) a cord having a handle portion at one end, a terminal loop at the other end, and a lengthwise portion of the cord therebetween;
ii) a ring attached to the terminal loop and through which the lengthwise portion of the cord is slidably disposed so as to provide a loop of adjustable size formed by a section of the lengthwise portion of the cord between the ring and the terminal loop;
iii) a fastener attached to the terminal loop for removably attaching the leash assembly to an animal collar; and,
iv) stop mean removably attachable to the lengthwise portion of the cord for inhibiting sliding movement of the ring towards the handle portion;
c) fitting the loop of adjustable size around a torso of the animal;
d) attaching the fastener to the collar of the animal; and
e) attaching the stop member on the lengthwise portion of the cord at a position adjacent to the ring and between the ring and the handle portion.

17. The method of claim 16 wherein the disk shaped stop member is fabricated from a resilient material.

18. The method of claim 17 wherein the disk shaped stop member includes an aperture and a radial slit extending from the aperture to a peripheral circumferential edge of the stop member.

19. The method of claim 18 wherein the aperture has a first diameter and the cord has a second diameter wherein the first diameter is less than the second diameter.

20. The method of claim 19 further comprising allowing the slit to open to form a gap such that the stop member resiliently grasps the cord.
